(19) United States
(12) Patent Application Publication
(10) Pub. No.: US 2013/0206253 A1
(43) Pub. Date: Aug. 15, 2013

(54) MICROFLUIDIC DEVICE AND METHOD FOR PRODUCING SAME

(71) Applicants: Dirk Kurowski, Gevelsberg (DE); Gert Blankenstein, Arlington, MA (US); Dirk Osterloh, Unna (DE); Marc Prenger, Hamm (DE); Ying Yu, Dortmund (DE)

(72) Inventors: Dirk Kurowski, Gevelsberg (DE); Gert Blankenstein, Arlington, MA (US); Dirk Osterloh, Unna (DE); Marc Prenger, Hamm (DE); Ying Yu, Dortmund (DE)

(21) Appl. No.: 13/810,468

(22) PCT Filed: Jul. 5, 2011
(86) PCT No.: PCT/EP11/61304

§ 371 Date: Apr. 3, 2013

(30) Foreign Application Priority Data
Jul. 19, 2010 (EP) 10007435.0

(51) Int. Cl. B01L 3/00; B23P 19/00

(52) U.S. Cl. CPC B01L 3/00; B23P 19/00
USPC 137/375; 29/428; 29/447

(57) ABSTRACT

A microfluidic device and a method of producing it are proposed, in which a film covers a chamber in a carrier. The film is locally re-tightened in the region of the chamber after the film has been secured to the carrier. In this way it is possible to prevent undesirable bulging of the film into the chamber.

The present invention relates to a preferably microfluidic device, particularly for receiving or handling a fluid, such as a liquid, according to the preamble of claim 1, and a process for producing such a device according to the preamble of claim 10.

The present invention is concerned with preferably microfluidic devices, particularly devices in which capillary forces act and are, in particular, critical to their operation.

Microfluidic devices are known which comprise a carrier consisting of plastics, in particular, with a film fixed thereon, the film covering at least one chamber and/or other channels in the carrier. The film is attached to the carrier preferably by lamination, heat-sealing, welding, adhesive bonding or the like. Particularly when fastening the film to the carrier by the effect of heat it has been found in practice that the part of the film covering the chamber has a tendency to sag or fall in. The film portion covering the chamber then deviates from the at least substantially planar form or bulges into the chamber. For microfluidics in particular this may result in the following disadvantages. The chamber height is reduced in the central region, so that the freedom of movement of an object present in this region is restricted or obstructed. The chamber cross-section deviates from its ideal rectangular shape or in the region of the film from a straight film wall, thus altering the filling characteristics of the chamber. The volume of the chamber is altered. The flow resistance of a fluid flowing through the chamber changes or is undefined.

The present invention is based on the problem of providing an in particular microfluidic device and a process for producing it, in which a chamber with an at least substantially flat covering provided by a film can be obtained very simply, particularly at little cost in terms of the process and/or apparatus used.

The above problem is solved by a device according to claim 1 or a process according to claim 10. Advantageous further features are the subject of the sub-claims.

In one aspect of the present invention, the device comprises tightening means for tightening the film portion that covers the chamber. This allows the film portion covering the chamber to be tightened, and in particular re-tightened. In particular, the tightening means allow additional action on the film portion that covers the chamber and long-lasting tightening of this film portion.

The tightening means preferably comprise a deformation region for the film. Particularly preferably, the deformation region is formed or arranged in or on the carrier, particularly on a flat side of the carrier facing the film.

For example, the deformation region may be a preferably groove-like depression in the carrier. After the (first) fixing of the film to the carrier outside the deformation region, for example by lamination or heat-sealing or adhesive bonding, the film can be deformed into the deformation region and thereby tightened. In this tightened state the film can be fixed, for example, by additionally securing it in the deformed region and/or in a (second or additional) fixing region between the deformation region and the chamber, once again particularly by lamination or heat-sealing or adhesive bonding. Particularly preferably, the tightening and additional securing are carried out simultaneously and/or by means of a single tool, such as a suitably designed thermode. Thus it is very simple to tighten or re-tighten the film in the region of a chamber and to fix the film in the tightened state.

Instead of or in addition to the depression, the deformation region may also have, or be formed by, an in particular bead-like elevation of the carrier. Thanks to the elevation it is possible in particular for the part of the film that covers the chamber to be tightened automatically when the film is (first) attached to the carrier, i.e. outside the elevation, if the elevation brings about local deformation and hence expansion and tightening of the film region of the chamber.

The deformation region preferably extends along one edge of the chamber. This contributes to uniform tightening of the film portion that covers the chamber.

Preferably, the deformation region surrounds the chamber at least substantially completely. This also contributes to uniform tightening of the film portion over the chamber.

Preferably a deformation region is provided or formed on opposite sides of the chamber. This allows uniform tightening of the film portion covering the chamber, while still allowing incoming or outgoing pipes or other fluidic structures, particularly between the deformation regions, to be connected laterally to the chamber.

Particularly preferably, the film is first attached to the carrier in a first attachment region and then, during tightening or after tightening, additionally connected to the carrier in a second attachment region, the second attachment region being located between the first attachment region and the chamber. The second attachment region—also referred to as the additional attachment region in some cases—then serves to fix the tightened film or the tightened state. The deformation region is then preferably arranged between the first and second attachment regions.

In another aspect of the present invention, the film portion covering the chamber is additionally tightened for securing the film to the carrier by an additional effect. Thus, the undesirable sagging or bulging of the film portion above the chamber can be counteracted, even if this sagging or bulging is initially caused by attaching the film to the carrier, particularly by the effect of heat.

As an additional effect, the film may be deformed in parts, particularly in the previously mentioned deformation region of the carrier or by some other method. This allows very easy tightening, for example by engaging a tool or tightening element in the deformation region or in a depression in the carrier that forms the deformation region.

According to an alternative feature, the film may also be directly connected to the carrier in the deformation region or in the deformed state. This may optionally also do away with the need for additional fastening in the second attachment region.

Preferably, as already mentioned, the film that has already been tightened or re-tightened over the chamber is additionally secured with or in an additional attachment region, such as the second attachment region, in order to fix the film with the tightened film portion over the chamber. This additional attachment may also take place at the same time as the deformation. Thus a particularly rapid process or very fast manufacture is made possible. Alternatively, the additional fixing may also take place after the deformation, particularly when preliminary fixing of the film in the tightened state is achieved by the deformation, e.g. in the deformation region.

According to another variant, as an additional tightening action, the already secured film is preferably heated briefly, particularly preferably substantially exclusively in the part of the film that covers the chamber. The heating is particularly preferably to above the glass transition temperature of the film. Thus re-tightening of the film can be carried out particularly easily. In fact, experiments have show that a very brief heating of the film is sufficient to carry out this thermal re-tightening.

The securing of the film on the carrier is particularly preferably carried out by lamination, as mentioned earlier. By the term “lamination” is meant, in particular, securing or connecting by the effect of heat and particularly the simultaneous application of pressure. For this, the film is preferably coated with an adhesive—also referred to as a sealing lacquer or hot-melt adhesive—which is heated or liquefied during the lamination and attaches the film to the carrier. However, the film may also be welded to the carrier. Preferably, the term “lamination” in the sense of the present invention may be understood as also including heat-sealing and/or otherwise connecting the film to the carrier, for example by adhesive bonding or welding.

By the term “chamber” is meant, according to the present invention, in particular any three-dimensional fluidic structure that can be manufactured according to the proposed method or is bounded—at least partially—by the film and serves to receive liquid or another fluid, possibly also gas.

The present invention relates in particular only to microfluidic devices. By “microfluidic” are meant here only volumes of the device as a whole or the chamber of less than 1 ml or less than 500 μl, preferably less than 100 μl, particularly preferably about 10 μl or less.

The aspects and features mentioned above and the aspects and features of the present invention that will become apparent from the following description may be implemented independently of one another and in any desired combination.

Further advantages, features, properties and aspects of the present invention will become apparent from the claims and the following description of preferred embodiments referring to the drawings, wherein:

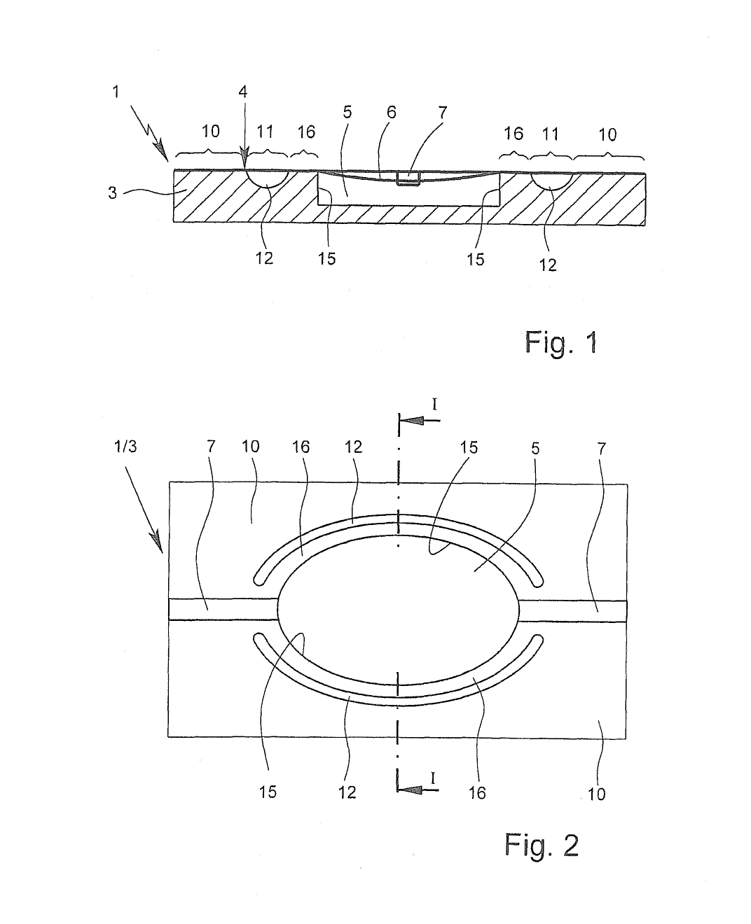

FIG. 1 is a schematic sectional view of a proposed device with a carrier and an associated film that has not yet been tightened in the region of a chamber;

FIG. 2 is a plan view of the carrier without a film;

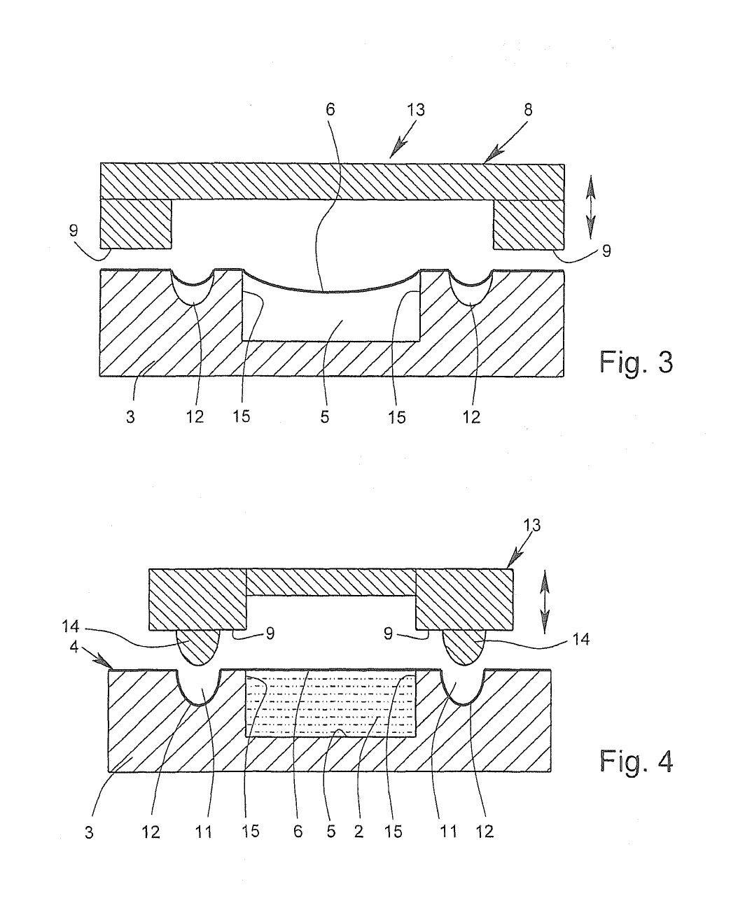

FIG. 3 is a schematic sectional view of the attachment of the film to the carrier using a tool;

FIG. 4 is a schematic sectional view of the tightening of the film using another tool;

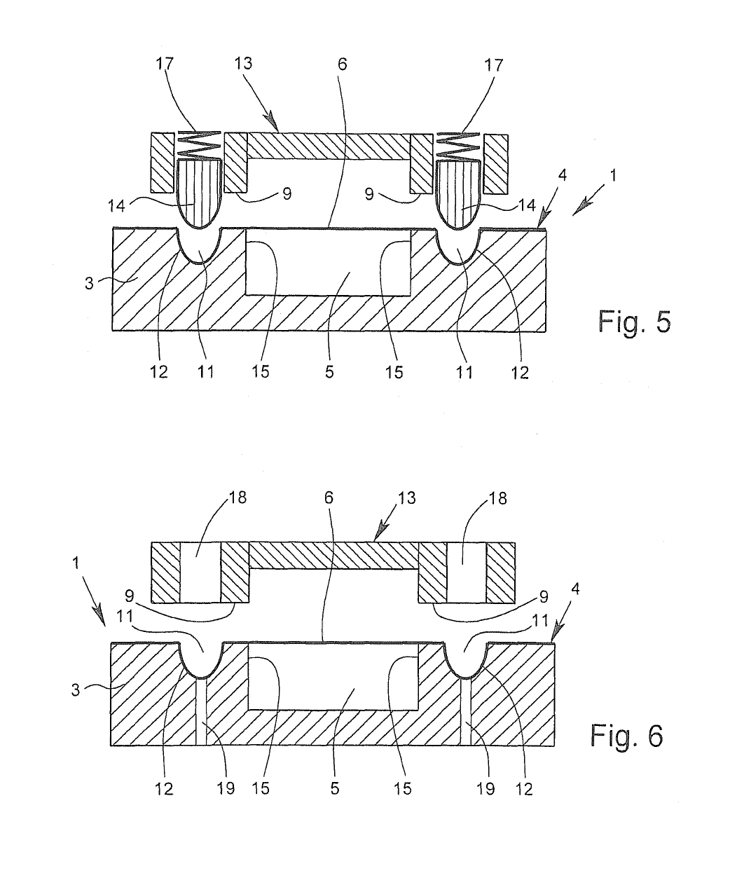

FIG. 5 is a schematic sectional view of the tightening of the film using a different tool;

FIG. 6 is a schematic sectional view of the tightening of the film using excess pressure or gas pressure;

FIG. 7 is a schematic sectional view of the tightening of the film using reduced pressure;

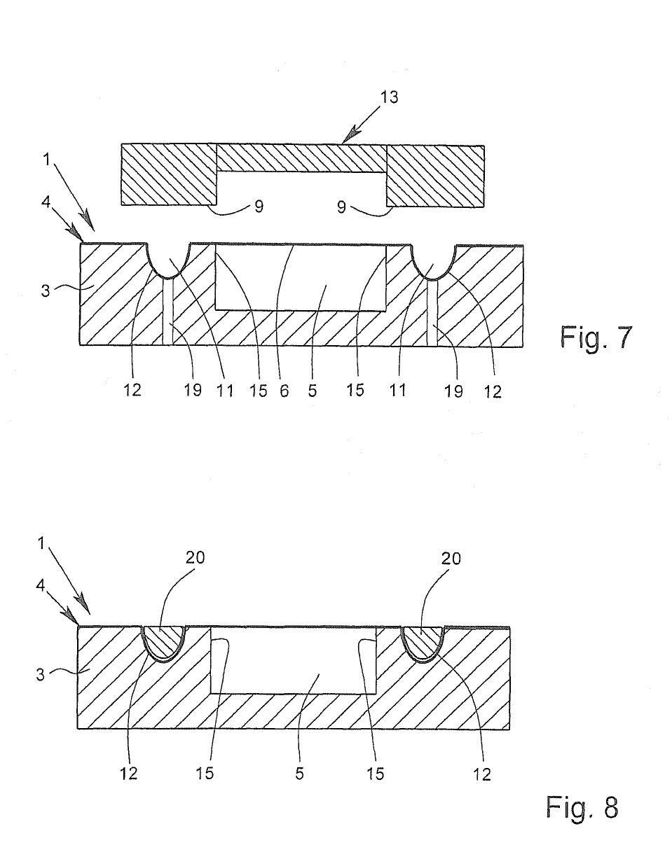

FIG. 8 is a schematic sectional view of the tightening of the film using a tightening element;

FIG. 9 is a schematic sectional view of another proposed device with an increased deformation region for tightening the film; and

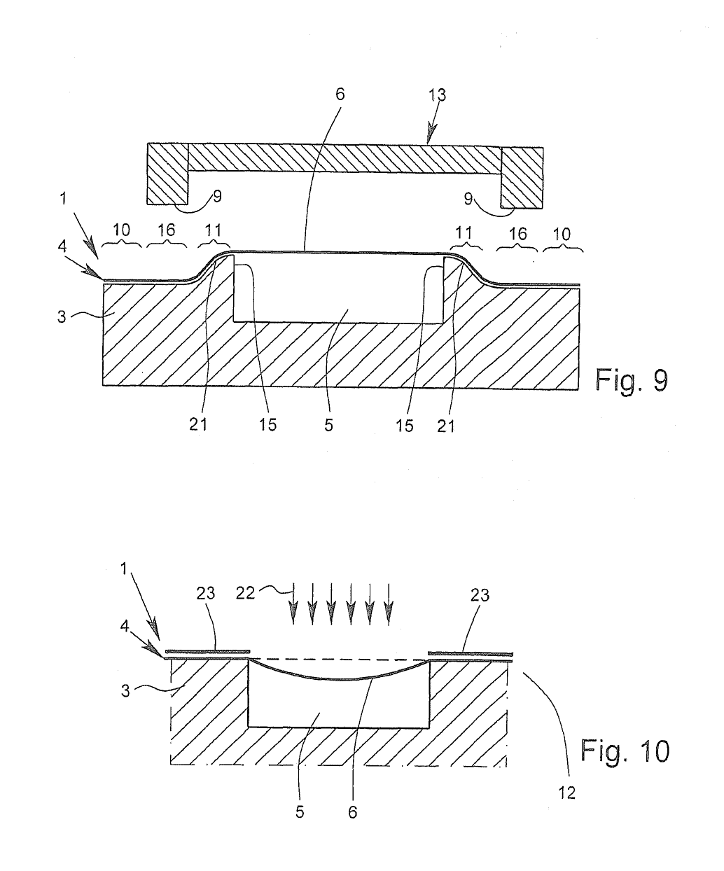

FIG. 10 is a schematic sectional view of the re-tightening of the film by the action of heat.

In the Figures the same reference numerals are used for identical or similar parts, while corresponding or comparable properties and advantages are obtained even if there is no repetition of the description. The Figures are not to scale, so as to illustrate various aspects and assist with understanding the description.

FIG. 1 shows in schematic section a proposed, especially microfluidic device 1 for receiving and/or handling a fluid, particularly a liquid. The fluid or liquid is not shown in FIG. 1. Rather, the schematic section in FIG. 4 shows the device 1 with the liquid 2, by way of example.

The device 1 has a carrier 3 and a film 4. The carrier 3 has a chamber 5 which is (wholly or partly) covered by the film 4. The film 4 is attached to the carrier 3 for this purpose, particularly by lamination or the like. It may happen that the part 6 of the film 4 that covers the chamber 5 sags or bulges into the chamber 5, as shown in FIG. 1. This may occur for example as a result of the effect of heat when securing or applying the film 4 to the carrier 3, as already explained hereinbefore.

FIG. 2 shows in a schematic plan view the carrier 3 or the device 1 with the film 4 being transparent or omitted. FIG. 1 shows a schematic section along the line I-I in FIG. 2 with the film 4.

The plan view in FIG. 2 shows that the device 1 or the carrier 3 may comprise other fluidic or microfluidic structures in addition to the chamber 5, such as one or more channels 7, other chambers or the like. In the embodiment shown, one or two channels 7 adjoin the chamber 5. The fluidic structures, like the chamber 5, are preferably formed by depressions in the carrier 3 which are preferably at least partly or completely covered by the film 4.

The fluidic structures are preferably at least predominantly or all arranged on a flat side of the carrier 3, particularly open towards the film 4 and/or covered by it.

The volumes of the microfluidic structures or the chamber 5 and/or channels 7 are preferably less than 1 ml, more particularly less than 500 ml, particularly preferably about 100 μl or less.

The chamber 5 may generally be of any desired shape, for example round, oval, oblong, angular or some other shape in plan view. The present invention can basically be used for any shape of the chamber 5, and even in oblong fluidic structures or chambers 5 extending as if into infinity in one direction.

The film portion 6 forms a wall of the chamber 5.

The film portion 6 is preferably continuously closed in its structure or preferably covers the chamber 5 continuously. However, the film 4 or the film portion 6 may also be partially interrupted or may only partly cover the chamber 5.

The film 4 is preferably made of plastics or in the form of a plastics film. Depending on the requirements it may be a single- or multi-ply film 4. Preferably a plastics film of polypropylene (PP) or polyethylene (PE) coated with a hot-melt adhesive may be used as the film 4.

The thickness of the film 4 is preferably about 0.01 mm to 1 mm, particularly about 0.1 mm to 0.5 mm.

The film 4 is attached to the carrier 3 or its flat side, particularly by lamination, i.e. under the effect of pressure and heat (particularly at about 70 to 170° C., particularly preferably about 80 to 100° C.). In the following description often lamination will be mentioned on its own for securing the film 4. However, in principle, the film 4 can also be attached to the carrier 3 by any other suitable method such as welding, for example by ultrasound, adhesive bonding or the like. The remarks and explanations that follow therefore preferably apply accordingly for other methods of attachment of the film 4.

First of all, the film 4 is first attached to the carrier 3 as shown schematically in FIG. 3. This is preferably done by lamination as schematically shown in FIG. 3. The lamination is carried out according to the proposal particularly using a (first) tool such as a mask and/or a so-called thermode 8 which is formed for example by a correspondingly constructed and/or heated punch or the like and/or is pressed against the film 4. The corresponding relative movement is indicated in FIG. 3 by a double arrow. If necessary, the mask or thermode 8 may also be formed by the surface of a roll or roller of a roller laminator or the like.

The mask or thermode 8 preferably does not form a continuous abutment surface here but rather only one or more specific abutment areas 9 for the film 4.

For the lamination, the thermode 8 is pressed, under the effect of heat, onto the film 4 which is resting on the carrier 3, particularly loosely to begin with. This causes the film 4 to be attached to the carrier 3, preferably only in the region of the abutment areas 9, and according to this embodiment in at least a first attachment region 10, particularly in a plurality of attachment regions 10, as schematically shown in FIG. 1.

The film 4 is preferably first of all attached to the carrier 3 or laminated on to it by the effect of heat. The film 4, which is preferably neither pre-formed nor three-dimensionally structured but smooth or flat, is laid on the carrier 3 and attached thereto. As already mentioned at the beginning and shown in FIG. 1, the film portion 6 that covers the chamber 5 may sag or bulge into the chamber 5, particularly as a result of the effect of heat when securing the film 4. To at least minimise or prevent this undesirable bulging into the chamber 5, the film 4 is tightened or re-tightened, at least in the region of the film portion 6.

As shown in FIG. 4, after the tightening of the film 4 the film portion 6 no longer bulges, or no longer noticeably bulges into the chamber 5, but extends at least substantially flat or at least substantially straight over the chamber 5 from one side of the chamber 5 to the opposite side.

The tightening or re-tightening of the film 4 will be explained in more detail hereinafter.

According to the proposal, the tightening of at least the film portion 6 that covers the chamber 5, in addition to the attachment of the film 4 to the carrier, is durably carried out preferably by an additional action or in a separate or second step. The action is, in particular, a mechanical action or deformation of the film 4. However, in principle this may also be achieved by corresponding deformation or adjustment of the carrier 3.

The device 1 preferably comprises a tightening means for tightening at least the film portion 6 that covers the chamber 5.

In the embodiment shown, the tightening means comprises at least one deformation region 11 for the film 4. The deformation region 11 is preferably formed or arranged in or on the carrier 3, particularly on a flat side of the carrier 3 facing the film 4. The deformation region 11 preferably has a depression 12 in the carrier 3 or is formed thereby. In particular, the depression 12 is in the shape of a groove or channel.

It should be noted that the device may have one or more fixing regions 10, deformation regions 11 and/or one or more depressions 12. The fixing region 10, the deformation region 11 or the depression 12 may surround the chamber 5 or its edge 15 circumferentially or continuously, particularly in an annular configuration. However, interruptions are possible, particularly for fluidically connecting the chamber 5, for example through at least one channel 7, as shown in the embodiment. In corresponding manner, a plurality of fixing regions 10, deformation regions 11 or depressions 12 may then be provided which are associated with only one chamber 5. Where the present invention refers to the fixing region 10, the deformation region 11 and the depression 12 only in the singular, this also applies accordingly when a plurality of fixing regions 10, deformation regions 11 or depressions 12 are provided.

For tightening the film 4 is preferably deformed into the deformation region 11 or the depression 12. This is preferably done using another or second tool, in this case another thermode 13, as diagrammatically shown in FIG. 4. The other tool or the other thermode 13 preferably has at least one projection 14 for engaging in the at least one deformation region 11 or the at least one depression 12. In this way, the film 4, particularly in the region located within the deformation region 11, or at least the film portion 6 is tightened. The film 4 is in fact already secured in the outer regions or in the first attachment regions 10, so that the film 4 is to this extent supported and at least substantially only tightened by deformation in the region located between the deformation regions 11 or an inner region. The deformation regions 11 or depressions 12 are thus preferably located within the first attachment region 10 or first attachment regions 10.

The deformation region 11 is preferably located between the first attachment region 10 and the chamber 5. In particular, the deformation region 11 separates the first deformation region 10 from the chamber 5.

The deformation region 11 preferably extends along the edge 15 of the chamber 5 and/or surrounds the chamber 5 preferably at least substantially completely.

Two deformation regions 11 are preferably arranged or formed on opposite sides of the chamber 5 in the embodiment shown.

FIG. 4 shows the device 1 with the film 4 already tightened or re-tightened. The film 4 is deformed into the deformation region 11 or the deformation regions 11, particularly by suitable engagement of the projections 14, and particularly preferably also attached to the carrier 3 in this region. At the least, in the embodiment shown the film 4 also abuts at least substantially or partially on the carrier 3, preferably in the depressions 12 as well.

However, the film 4 does not necessarily have to be connected to the carrier 3 in the deformation region 11 or in the depression 12. Accordingly, the projection 14 engaging in the deformation region 11 or in the depression 12 only has to ensure sufficient deformation and tightening of the film 4 but not abutment of the film 4 in this region to the carrier 3. The projection 4 therefore does not have to be shaped so as to match the depression 12. Rather, the shape may be optimised so that the film 4 is not excessively expanded or tightened towards the first attachment region 10, i.e. outwardly or on the side of the projection 14 remote from the chamber 5, but is sufficiently expanded and hence tightened in the desired manner on the chamber side.

Attachment of the tightened film 4 in the deformation region 11 or in the depression 12 may be sufficient for fixing the tightened state. Alternatively or additionally, the film is preferably also attached in a second attachment region 16 (in two or more attachment regions 16, in the embodiment shown). This additional fixing serves to fix the film 4 in the tightened state. In the following description reference will frequently be made to only one attachment region 16, even though a plurality of second/additional attachment regions 16 may be provided. The explanations will then apply accordingly.

The second attachment region 16 is preferably arranged within the first attachment region 10 and/or the deformation region 11.

The second attachment region 16 is preferably arranged between the first attachment region 10 or deformation region 11 on the one hand and the chamber 5 on the other hand.

The second attachment region 16 preferably extends along the edge 15 of the chamber 5 and/or around the chamber 5 and preferably surrounds it at least substantially completely.

The second attachment region 16, like the first attachment region 10 and/or the deformation region 11, may also be ring-shaped and/or arranged concentrically thereto and/or interrupted in parts (for example for fluidic connection through one or more channels 7 or the like).

The attachment of the film 4 in the second attachment region 16—in the two attachment regions 16 in the embodiment shown—is preferably carried out immediately after the deformation or drawing of the film into the depressions 12. In particular, the attachment in the second attachment region 16 is carried out using the second tool or the second thermode 13, which has corresponding abutment regions 9, particularly within the projection 14 or projections 14. It should be noted in this context that the projection 14 of the tool or the thermode 13 may also be ring-shaped or circumferential, with a corresponding configuration of the deformation region 11 or the depression 12 or the attachment region 16.

In the embodiment shown, the film 4 is also laminated onto the carrier 3 in the second attachment region 16. Preferably there is thus a corresponding or similar connection of the film 3 in the first attachment region 10, in the deformation region 11 or in the depression 12 and/or in the second attachment region 16. However, the film 4 may also be secured in the various regions 10, 11, 16 by some other method.

The film 4 is joined to the carrier 3 in the various regions 10 and 16 (and optionally 11) preferably at least substantially over its entire surface. However, if required, the film 4 may also be attached to the carrier 3 only in subsidiary regions or at different locations or points, for example in order to fix the film 4 in its tightened state.

In the embodiment shown, the first fixing of the film 4 to the carrier 3 in the first attachment region 10 is preferably carried out in a first step or using the first tool or the first thermode 8.

Then, in a second separate step, the tightening of the film 4, particularly at least the film portion 6 above the chamber is carried out. Tightening is preferably carried out using the second tool or the second thermode 13.

However, the tightening may also take place simultaneously or substantially simultaneously with the first fixing of the film 4 to the carrier 3. In this case it may be advisable to tighten the film 4 as a whole, i.e. not to lay it loosely on the carrier 3, but to attach the tightened or pre-tightened film on the carrier 3. In contrast, in the embodiment shown, only local or partial tightening of the film 4 is carried out, i.e. only a part of the film is tightened such as the film portion 6 and optionally an adjacent circumferential region of the film 4.

In the embodiment shown, the fixing of the film 4 in the tightened state is preferably carried out at least substantially at the same time as the deformation or tightening of the film 4. The fixing of the tightened film 4 is preferably carried out by securing the film 4 in the deformation region 11 or in the depression 12 and/or in the second attachment region 16. The fixing or additional attachment of the tightened film 4 is preferably carried out in the embodiment shown by means of the second tool or the second thermode 13 which also serves to tighten the film 4. However, it is also possible to use an additional separate tool or an additional separate thermode for this purpose.

Further embodiments or alternative features of the present invention will be explained in more detail hereinafter with reference to the other Figures. Only essential differences from the embodiment already described will be explained in detail or emphasised. The previous embodiments and explanations therefore apply in a supplementary or corresponding capacity, even if there is no repetition of the relevant description.

FIG. 5 shows, in a schematic sectional view corresponding to FIG. 4, an alternative embodiment with a modified thermode 13. The projections 14, i.e. the deforming means engaging in the deformation regions 11 or depressions 12, are preferably elastically biased and/or movable or deformable to ensure optimum engagement in the depressions 12 and/or in order to tighten the film 4 with a specific force. This force depends in particular on the biasing of the projections 14 or associated springs 17 for biasing the projections 14 or for resiliently mounting the projections 14.

In the embodiment shown the engaging means or projections 14 are preferably thermally disconnected from the other abutment regions 9 of the tool or the thermode 13, more particularly are heat-insulated, so as to reduce or minimise the thermal loading of the film 4 in the deformation regions 11 during the deformation.

FIG. 6 shows, in a view similar to FIG. 5, another embodiment. For the tightening, the film 4 is preferably deformed into the deformation region 11 using excess pressure or gas pressure, particularly by the introduction of pressurised gas or compressed air and in this way the film 4 is tightened. The second thermode 13 may comprise, for this purpose, one or more gas feeds 18, as shown in FIG. 6. Additionally, one or more venting channels 19 may be formed in the carrier 3 in order to vent the deformation regions 11 or depressions 12, so that the film 4 is able to be deformed by the excess pressure that is preferably applied by the tool or thermode.

FIG. 7 shows another embodiment, in a similar view. Here, the film 4 is preferably deformed and thereby tightened by the application of reduced pressure, particularly on the carrier side. In particular, the reduced pressure is applied through one or more venting channels 19 to one or more deformation regions 11 or the depression(s) 12. The additional thermode 13 may then comprise in particular a continuous or smooth contact surface 9, particularly without projections 14, in order to fix the film 4 in the tightened state, particularly to join it to the carrier 3 in the second attachment region 16.

In all the embodiments described up to now, it should fundamentally be noted that the deformation region 11 is preferably somewhat spaced from the first attachment region 10, i.e. preferably an intermediate region is formed in which the film 4 is not attached to the carrier 3 during the first fixing. Thus, the film 4 is still able to expand to some extent in this intermediate region during the deformation into the deformation region 11. In particular, in this case the additional thermode 13 is also able to join the film 4 to the carrier 3 in a region outside the deformation region 11 or in the above-mentioned intermediate region.

In the first two embodiments shown, the tightening is preferably carried out by the engagement or application of the additional tool or the additional thermode 13 or by the temporary engagement of deformation means such as the projections 14. Alternatively, the tightening and optionally also the fixing of the film 4 in the tightened state may also be carried out by putting on, inserting and/or engaging another component, for example inserting a tightening element 20 as shown in FIG. 8 in the deformation region 11 or the depression 12, so as to tighten the film 4 and fix it in the tightened state. In contrast to the tool or the thermode 13 the tightening element 20 is not then removed again. Instead, it may for example be connected to the carrier 3 and/or the film 4. In particular, it may be useful to press the tightening element 20 or the tightening elements 20 into the depressions 12.

FIG. 8 shows another embodiment, in a schematic section at least substantially corresponding to FIGS. 4 to 7. Here, the tightening element 20 engages in the deformation region 11 or the depression 12, in order to deform the film 4 and thereby tighten it and/or to secure the film 4 in the tightened state. In contrast to the tool or the thermode 13 or the projection 14, the engagement is preferably permanent in this case. The tightening element 20 is preferably not detached from the device 1 again but preferably forms part of the device 1. For example, the tightening element 20 may be attached or secured by frictional engagement, for example by pressing in or clamping, and/or by interlocking engagement, for example by means of a suitable undercut. Alternatively or additionally, the tightening element 20 may also be connected to the film 4 and/or the carrier 3, for example by partial penetration of the film 4, particularly in fixed or non-releasable manner.

In the embodiment shown in FIG. 8, the tightening means accordingly comprises the tightening element 20, particularly a plurality of tightening elements 20 (two tightening elements 20, in the embodiment shown), which engages or is inserted in associated deformation regions 11 or depressions 12.

FIG. 9 shows, in a schematic sectional view, another embodiment or alternative. The deformation region 11 or the tightening means here comprises, or is formed by, an elevation 21 that preferably forms the edge 15 of the chamber 5. The elevation 21 is preferably formed by the carrier 3 or is in particular formed in one piece therewith. However, the elevation 21 may also be formed by another component which is mounted loosely or fixedly on the carrier 3. The elevation 21 projects in particular over the flat side of the carrier 3 or from the carrier 3, in order to ensure the desired, preferably only local tightening of the film 2 or the film portion 6 in the region of the chamber 5.

The elevation 21 preferably extends at least substantially around the chamber 5 and/or along the edge 15 of the chamber 5. In particular, elevations 21 may be provided on opposite sides of the chamber 5. Correspondingly, the tightening means may in this case have a plurality of elevations 21 associated with the same chamber 5.

In the embodiment shown, a single fixing or first fixing of the film 4 to the carrier 3, particularly in the attachment regions 10, may be sufficient, as the tightening means or the elevation 21 ensures that during the fixing—particularly with the film 4 being correspondingly held at the edges—it is tightened over the chamber 5 and fixed in this tightened state. In this case, the attachment regions 10 may extend as far as the elevation 21 and/or the second attachment regions 16 may be omitted.

However, the attachment and tightening may also be carried out in two steps. For example, in the first step there may only be an outer or marginal first fixing of the film 4 on the carrier 3, i.e. in the attachment regions 10. Then in a second step the tightening or additional/second fixing may take place, while the film 4 is then particularly preferably secured to the carrier 3 in the second attachment region 16 between the outer first attachment region and the elevation 21 and thereby tightened uniformly over the chamber 5. The second fixing is thus also carried out around the elevation(s) 21 or immediately adjacent thereto. In contrast to the other embodiments and variants, the deformation region 11 (the elevation 21) is arranged here within the second attachment region 16 and/or between the chamber 5 and the second attachment region 16.

FIG. 10 shows another embodiment or variant, in a similar schematic sectional view. Here, the re-tightening of the film 4 or the film portion 6 after the film 4 has been attached to the carrier 3 is carried out in a separate step by preferably brief heating, particularly by heat radiation 22. Preferably, the areas that are not to be heated are covered by a mask 23 to achieve only local heating, particularly only of the film portion 6 that is to be re-tightened. The heating is preferably carried out by infra-red radiation and/or microwave radiation or other suitable radiation.

The heating is preferably carried out only briefly, particularly for less than 1 s, particularly preferably less than 0.5 s, particularly preferably less than 0.1 s.

Preferably, heating is carried out to above the glass transition temperature of the film material (particularly the material that forms the covering layer or top layer of the film 4) and/or to a temperature which is above the heating temperature during the fixing of the film 4 to the carrier 3, particularly preferably by at least 10° C. or 20° C. higher. The heating temperature during the re-tightening is preferably above the softening temperature of the film 4 or the covering layer of the film 4.

The proposed heat treatment or heating causes the film 4 to shrink, particularly by more than 0.5%, particularly preferably by more than 1%, thus achieving the desired tightening or re-tightening.

In FIG. 10 the tightened state of the film 4 or the film portion 6 is shown by dashed lines.

Generally, the following should be noted for all embodiments and variants:

The carrier 3 is preferably made of plastics, particularly polystyrene or polycarbonate and/or produced by injection moulding.

The carrier 3 is preferably at least substantially plate-shaped, flat and/or planar in construction and/or provided with a flat side.

The carrier 3 is preferably at least substantially rigid in construction.

The carrier 3 or its surface is preferably formed from a material which is more temperature resistant than the film 4 or its heat-sealing layer or hot-melt adhesive.

The film 4 is preferably made of plastics, particularly polyethylene or polypropylene.

The film 4 is transparent or opaque, as required, optionally only in parts.

The film 4 is of single- or multi-ply construction, as desired. This also depends on the intended applications or requirements in each case.

In particular the film 4 is a so-called heat-sealing film which conventionally has a coating of hot melt adhesive or a thermoplastic adhesive, also known as a sealing lacquer.

As already mentioned, the film 4 may also cover or form one or more chambers 5 or fluidic structures in or on the carrier 3.

The device 1 constructed and/or produced according to the proposal may be used for a variety of purposes and in particular also combined with other, in particular microfluidic systems, components such as valves, pumps, capillary stops, filters, detecting devices or the like.

The proposed device 1 may also be used for example for the analysis or other treatment or handling of fluids such as the liquid 2.

In general the various embodiments and alternative embodiments may also be combined with one another as desired. In addition, individual aspects and features of the various embodiments and alternatives may be combined with one another as desired and/or used in other similar devices and processes, particularly in microfluidics.

### LIST OF REFERENCE NUMERALS

1 device
2 liquid
3 carrier
4 film
5 chamber
6 film portion
7 channel
8 first thermode
9 abutment region
10 first attachment region
11 deformation region
12 depression
13 second thermode
14 projection
15 edge
16 second attachment region
17 spring
18 gas feed
19 venting channel
20 tightening element
21 elevation
22 heat radiation
23 mask

1. Device (1), having a carrier (3), a film (4) attached to the carrier (3) and a chamber (5) formed in the carrier (3) and open towards the film (4), which is covered by a film portion (6) of the film (4),
characterised in that
the device (1) comprises a tightening means for tightening the film portion (6).

2. Device according to claim 1, characterised in that the tightening means has a deformation region (11) for the film (4).

3. Device according to claim 2, characterised in that the deformation region (11) is formed or arranged in or on the carrier (3) on a flat side of the carrier (3) facing the film (4).

4. Device according to claim 2, characterised in that the deformation region (11) comprises or is formed by a groove-like depression (12) in the carrier (3) and/or the film (4) is deformed into the deformation region (11) at least substantially abuts thereon or is connected thereto.

5. Device according to claim 2, characterised in that the deformation region (11) comprises or is formed by a bead-like elevation (21) of the carrier (3), that forms an edge (15) of the chamber (5).

6. Device according to claim 2, characterised in that the deformation region (11) extends along an edge (15) of the chamber (5) and/or at least substantially completely surrounds the chamber (5).

7. Device according to claim 2, characterised in that in each case a deformation region (11) is arranged or formed on opposite sides of the chamber (5).

8. Device according to claim 1, characterised in that the film (4) is connected to the carrier (3) in a first attachment region (10) and in a second attachment region (16), while the second attachment region (16) is arranged between the first attachment region (10) and the chamber (5).

9. Device according to claim 2, characterised in that the deformation region (11) is arranged between the first and second attachment regions (10, 16).

10. Method of producing a device (1) embodied according to claim 1, wherein a film (4) is attached to a carrier (3) and covers a chamber (5) in the carrier (3) that is open towards the film (4),
characterised in that
a film portion (6) covering the chamber (5), in addition to securing the film (4) on the carrier (3), is permanently tightened in parts by an additional action.

11. Method according to claim 10, characterised in that to tighten it the film (4) is deformed in parts into a deformation region (11) of the carrier (3), as an additional action.

12. Method according to claim 11, characterised in that the film (4) is additionally secured on the carrier (3) with or in an additional attachment region (16), between the deformation region (11) and the chamber (5).

13. Method according to claim 12, characterised in that the additional attachment is carried out simultaneously with or after the deformation.

14. Method according to one of claim 10, characterised in that the tightening and the fixing of the tightened film (4) are carried out in a second step after the first fixing of the film (4) on the carrier (3).

15. Method according to claim 14, characterised in that the tightening of the already secured film (4) is carried out by briefly heating the film (4) at least substantially only the film portion (6).
